(19) United States
(12) Patent Application Publication
(10) Pub. No.: US 2026/0266737 A1
(43) Pub. Date: Sep. 10, 2026

(54) INSPECTION APPARATUS AND DETERMINATION MODEL GENERATION METHOD

(71) Applicant: ASTEMO, LTD., Tokyo (JP)

(72) Inventors: Takumi NITO, Hitachinaka-shi, Ibaraki (JP); Yoshihiko KOBAYASHI, Hitachinaka-shi, Ibaraki (JP); Naoki HOSOYA, Hitachinaka-shi, Ibaraki (JP); Takashi WATANABE, Hitachinaka-shi, Ibaraki (JP); Masatoshi ICHINOSE, Hitachinaka-shi, Ibaraki (JP)

(21) Appl. No.: 19/163,564

(22) PCT Filed: Feb. 9, 2024
(86) PCT No.: PCT/JP2024/004462

§ 371 Date: Sep. 9, 2025

(30) Foreign Application Priority Data
May 30, 2023 (JP) 2023-088315

(51) Int. Cl. G01N 21/88; G06T 7/00

(52) U.S. Cl. CPC G01N 21/8851; G06T 7/00; G01N 2021/8864; G06T 2207/20024; G06T 2207/20081

(57) ABSTRACT

An inspection apparatus includes a pseudo defect target image generation portion configured to generate a pseudo defect target image by synthesizing a pseudo defect element image mimicking a defective portion with a normal target image. The pseudo defect target image generation portion is configured to change at least one of a state of the pseudo defect element image, a synthesization position in the normal target image, or a state of the synthesization position in the normal target image according to the synthesization position in the normal target image at which the pseudo defect element image is synthesized, the state of the synthesization position in the normal target image, and the state of the pseudo defect element image, and synthesize the pseudo defect element image at the synthesization position in the normal target image. The inspection apparatus further includes a learning processing portion, and a determination processing portion.

### TECHNICAL FIELD

The present invention relates to an inspection apparatus and a determination model generation method.

### BACKGROUND ART

PTL 1 discloses an inspection apparatus including a learning data generation portion that generates learning data, which is image data of a learning image formed by synthesizing a defective portion image with an acceptable product image, based on defective portion data, acceptable product data, and a generation parameter for determining whether an inspection target is acceptable or defective.

### CITATION LIST

### Patent Literature

PTL 1: Japanese Patent Application Laid-Open No. 2020-27424

### SUMMARY OF INVENTION

### Technical Problem

However, the inspection apparatus disclosed in PTL 1 has such a problem that the generation parameter is generated by being selected randomly, generated according to a preliminary rule, or generated based on a user input, and therefore is prepared without consideration of the state of the acceptable product image or the defective portion image, thereby raising a possibility of impairing the accuracy of determining whether the inspection target is acceptable or defective.

One of objects of the present invention is to provide an inspection apparatus and a determination model generation method capable of improving determination accuracy of an inspection.

### Solution to Problem

According to one aspect of the present invention, an inspection apparatus includes a pseudo defect target image generation portion configured to generate a pseudo defect target image by synthesizing a pseudo defect element image mimicking a defective portion with a normal target image. The pseudo defect target image generation portion is configured to change at least one of a state of the pseudo defect element image, a synthesization position in the normal target image, or a state of the synthesization position in the normal target image according to the synthesization position in the normal target image at which the pseudo defect element image is synthesized, the state of the synthesization position in the normal target image, and the state of the pseudo defect element image, and synthesize the pseudo defect element image at the synthesization position in the normal target image. The inspection apparatus further includes a learning processing portion configured to generate a determination model by causing the pseudo defect target image to be machine-learned, and a determination processing portion configured to detect the defect from a target image acquired by imaging the inspection target using the determination model.

According to the one aspect of the present invention, the determination accuracy of the inspection can be improved.

### BRIEF DESCRIPTION OF DRAWINGS

FIG. 1 is an overall view of an inspection apparatus according to a first embodiment.

FIG. 2 is a block diagram illustrating the inside of a computer according to the first embodiment.

FIG. 3 is a flowchart illustrating an operation of a pseudo defect target image generation portion according to the first embodiment.

FIG. 4 illustrates a state parameter of a synthesization position in a normal target image according to the first embodiment.

FIG. 5 illustrates a state parameter of a pseudo defect element image according to the first embodiment.

FIG. 6 is a graph indicating the relationship between a luminance of the synthesization position in the normal target image and an optimum luminance of the pseudo defect element image according to the first embodiment.

FIG. 7 is a graph indicating a luminance difference between the luminance of the synthesization position in the normal target image and the optimum luminance of the pseudo defect element image according to the first embodiment.

FIG. 8 illustrates an operation of a state parameter processing portion based on a state parameter history in a state parameter history storage portion according to the first embodiment.

FIG. 9 illustrates an operation of the state parameter processing portion using a feature point according to the first embodiment.

FIG. 10 illustrates an operation of the state parameter processing portion using a set boundary specifying mask image according to the first embodiment.

FIG. 11 illustrates a state parameter of the synthesization position in the normal target image according to a second embodiment.

FIG. 12 illustrates a change in an angle of the pseudo defect element image at the synthesization position on a region boundary according to the second embodiment.

FIG. 13 illustrates a filter processing of the synthesization position in the normal target image according to a third embodiment.

### DESCRIPTION OF EMBODIMENTS

### First Embodiment

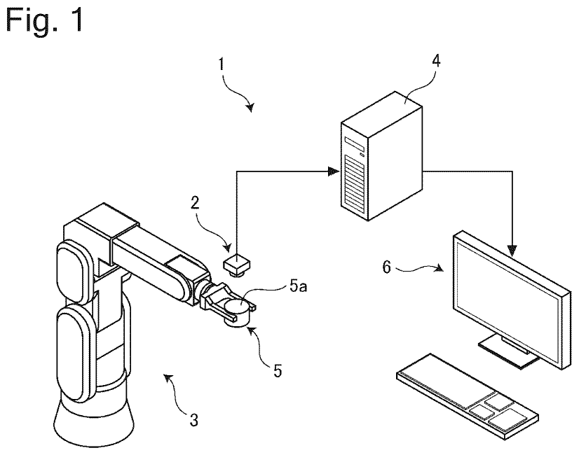

FIG. 1 is an overall view of an inspection apparatus according to a first embodiment.

The inspection apparatus 1 according to the first embodiment includes a camera 2, a robot 3, a computer 4, and a determination result display portion 6.

The camera 2 captures an image of a crown surface 5a of a piston (an inspection target) 5.

The crown surface 5a of the piston 5 has a machined surface (a surface type or a state) having a cut mark, and an as-cast surface (the surface type or the state) significantly different from each other in surface property.

The robot 3 changes the pose of the piston 5 relative to the camera 2.

The computer 4 is, for example, a personal computer.

The determination result display portion 6 displays a determination result of determining a defect in the target image indicating the crown surface 5a of the piston 5 imaged by the camera 2.

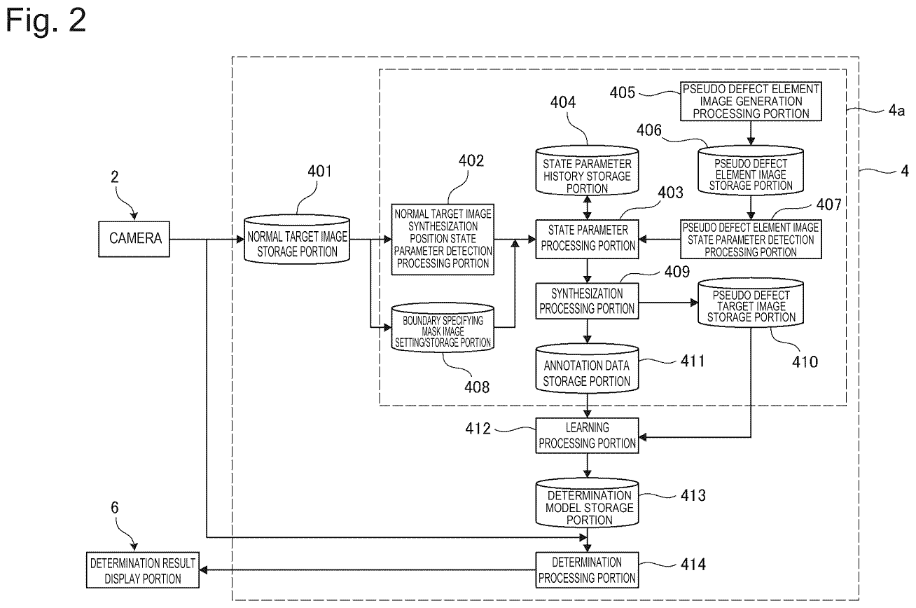

FIG. 2 is a block diagram illustrating the inside of the computer according to the first embodiment.

### Configuration of Computer

The computer 4 includes a normal target image storage portion 401, which stores a plurality of normal target images captured by the camera 2, a normal target image synthesization position state parameter detection processing portion 402, a state parameter processing portion 403, a state parameter history storage portion 404, a pseudo defect element image generation processing portion 405, a pseudo defect element image storage portion 406, a pseudo defect element image state parameter detection processing portion 407, a boundary specifying mask image setting/storage portion 408, a synthesization processing portion 409, a pseudo defect target image storage portion 410, an annotation data storage portion 411, a learning processing portion 412, a determination model storage portion 413, and a determination processing portion 414, which makes an acceptable/defective-product determination for determining a defect in the target image indicating the crown surface 5a of the piston 5 imaged by the camera 2 (a determination step) and transmits the determination result to the determination result display portion 6.

A pseudo defect target image generation portion 4a is constituted by the normal target image synthesization position state parameter detection processing portion 402, the state parameter processing portion 403, the state parameter history storage portion 404, the pseudo defect element image generation processing portion 405, the pseudo defect element image storage portion 406, the pseudo defect element image state parameter detection processing portion 407, the boundary specifying mask image setting/storage portion 408, the synthesization processing portion 409, the pseudo defect target image storage portion 410, and the annotation data storage portion 411.

The learning processing portion 412 conducts machine learning using coordinate data of a pseudo defect target image stored in the annotation data storage portion 411 and the pseudo defect target image stored in the pseudo defect target image storage portion 410, and stores a machine learning result into the determination model storage portion 413 (a determination model generation step).

This machine learning is, for example, learning using a neural network, and deep learning, which is a multi-layered version of a neural network, is employed in the first embodiment.

### Operation of Pseudo Defect Image Generation Portion

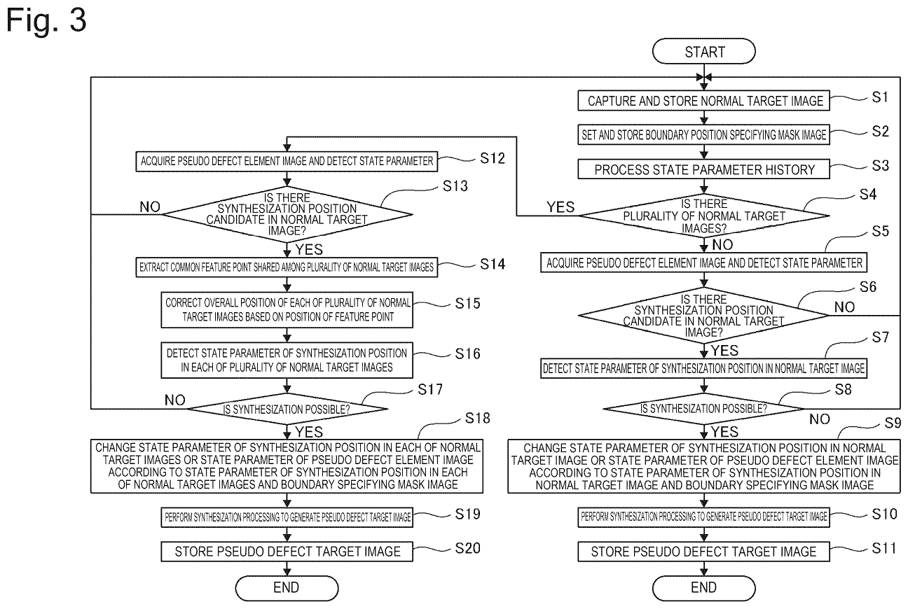

FIG. 3 is a flowchart illustrating an operation (a synthesization step) of the pseudo defect target image generation portion according to the first embodiment.

In step S1, the pseudo defect target image generation portion acquires a normal target image captured by the camera 2, and stores it into the normal target image storage portion 401.

In step S2, the boundary specifying mask image setting/storage portion 408 sets a boundary specifying mask image, and stores it.

In step S3, the pseudo defect target image generation portion processes a state parameter history stored in the state parameter history storage portion 404.

In step S4, the pseudo defect target image generation portion confirms whether there is a plurality of normal target images stored in the normal target image storage portion 401.

If there is not a plurality of normal target images, the processing proceeds to step S5, If there is a plurality of normal target images, the processing proceeds to step S12.

In step S5, the pseudo defect target image generation portion acquires a pseudo defect element image mimicking a defective portion, which is generated by the pseudo defect element image generation portion 405 and stored in the pseudo defect element image storage portion 406, detects a state parameter (the state) of the pseudo defect element image by the pseudo defect element image state parameter detection processing portion 407, and transmits it to the state parameter processing portion 403.

In step S6, the pseudo defect target image generation portion acquires the normal target image stored in the normal target image storage portion 401, and determines whether there is a synthesization position candidate.

If there is a synthesization position candidate, the processing proceeds to step S7. If there is no synthesization position candidate, the processing returns to step S1.

In step S7, the pseudo defect target image generation portion detects a state parameter (state) of the synthesization position in the normal target image by the normal target image synthesization position state parameter detection processing portion 402, and transmits it to the state parameter processing portion 403.

In step S8, the pseudo defect target image generation portion confirms whether the synthesization is possible based on the state parameter of the synthesization position in the normal target image.

If the synthesization is possible, the processing proceeds to step S9. If the synthesization is not possible, the processing returns to step S1.

In step S9, the state parameter processing portion 403 changes the state parameter of the synthesization position in the normal target image or the state parameter of the pseudo defect element image according to the state parameter of the synthesization position in the normal target image and the boundary position specifying mask image stored in the boundary specifying mask image setting/storage portion 408.

The state parameter processing portion 403 transmits and stores the synthesization position in the normal target image, the state parameter of the synthesization position in the normal target image, and the changed state parameter of the pseudo defect element image to the state parameter history storage portion 404.

In step S10, the synthesization processing portion 409 performs processing for synthesizing the pseudo defect element image at the synthesization position in the normal target image, thereby generating the pseudo defect target image.

In step S11, the pseudo defect target image generation portion stores the generated pseudo defect target image into the pseudo defect target image storage portion 410 and the coordinate data of the generated pseudo defect target image into the annotation data storage portion 411.

In step S12, the pseudo defect target image generation portion acquires the pseudo defect element image mimicking the defective portion and corresponding to the plurality of normal target images, which is generated by the pseudo defect element image generation processing portion 405 and stored in the pseudo defect element image storage portion 406, and detects the state parameter of the pseudo defect element image by the pseudo defect element image state parameter detection processing portion 407 and transmits it to the state parameter processing portion 403.

In step S13, the pseudo defect target image generation portion acquires the plurality of normal target images stored in the normal target image storage portion 401, and confirms whether there is a synthesization position candidate for each of them.

If there is a synthesization position candidate, the processing proceeds to step S14. If there is no synthesization position candidate, the processing returns to step S1.

In step S14, the pseudo defect target image generation portion extracts a location and a shape, which serve as a common feature point shared among the plurality of normal target images.

In step S15, the pseudo defect target image generation portion corrects the overall position of each of the plurality of normal target images based on the location and the shape serving as the feature point.

In step S16, the pseudo defect target image generation portion detects the state parameter of the synthesization position in each of the plurality of normal target images by the normal target image synthesization position state parameter detection processing portion 402, and transmits it to the state parameter processing portion 403.

In step S17, the pseudo defect target image generation portion confirms whether the synthesization is possible based on the state parameter of the synthesization position in the normal target image.

If the synthesization is possible, the processing proceeds to step S18. If the synthesization is not possible, the processing returns to step S1.

In step S18, the state parameter processing portion 403 changes the state parameter of the synthesization position in each of the normal target images or the state parameter of the pseudo defect element image according to the state parameter of the synthesization position in each of the normal target images and the boundary position specifying mask image stored in the boundary specifying mask image setting/storage portion 408.

In step S19, the synthesization processing portion 409 performs processing for synthesizing the pseudo defect element image at the synthesization position in the normal target image, thereby generating the pseudo defect target image.

In step S20, the pseudo defect target image generation portion stores the generated pseudo defect target image into the pseudo defect target image storage portion 410 and the coordinate data of the generated pseudo defect target image into the annotation data storage portion 411.

In this manner, the pseudo defect target image generation portion is configured to detect the state parameter of the synthesization position in the normal target image, change the state parameter of the synthesization position in the normal target image or the state parameter of the pseudo defect element image according to the state parameter of the synthesization position in the normal target image, synthesize the pseudo defect element image at the synthesization position in the normal target image to generate the pseudo defect target image, thereby being able to generate a pseudo defect target image close to an actual defect and improve the determination accuracy of the inspection.

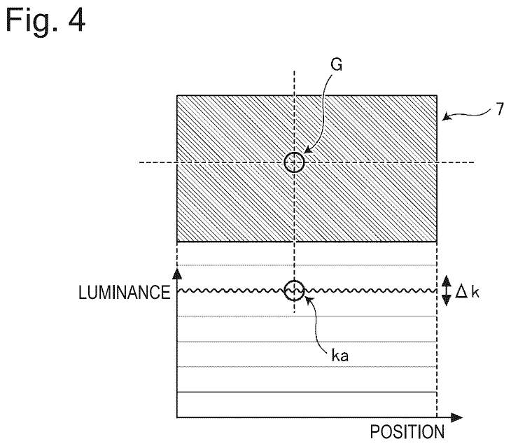

FIG. 4 illustrates the state parameter of the synthesization position in the normal target image according to the first embodiment.

In the first embodiment, a luminance (a background luminance) ka of a synthesization position G in a normal target image 7 is used as the state parameter (the state) of the synthesization position in the normal target image by the normal target image synthesization position state detection processing portion 402.

The detected synthesization position G and luminance ka of the synthesization position G are transmitted to the state parameter processing portion 403.

A luminance variation Δk may be used instead of the luminance ka.

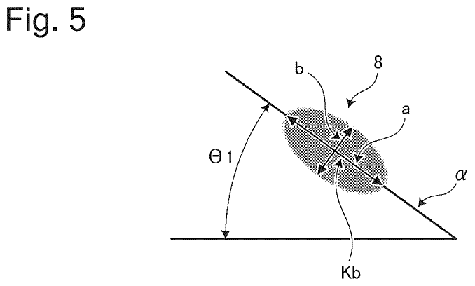

FIG. 5 illustrates the state parameter of the pseudo defect element image according to the first embodiment.

Any one of a type (a hole or a scratch), a major diameter a (a size), a minor diameter b (the size), an aspect ratio (=major diameter a: minor diameter b), an angle θ1 of an axis α of a major diameter direction, and a luminance kb, or a combination of a plurality of items among them can be used as the state parameter (the state) of a pseudo defect element image 8 by the pseudo defect element image state parameter detection processing portion 407.

In the first embodiment, the luminance kb is used as the state parameter of the pseudo defect element image 8.

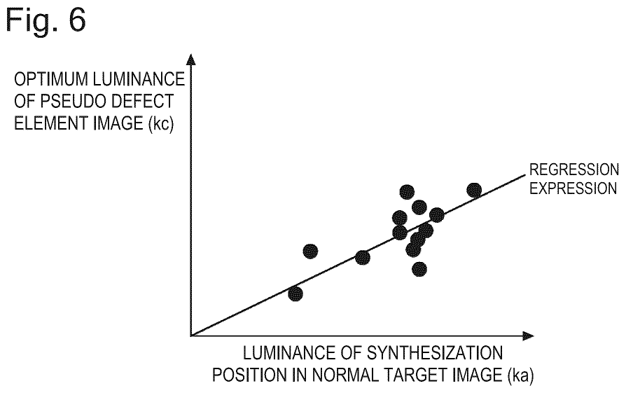

FIG. 6 is a graph indicating the relationship between the luminance of the synthesization position in the normal target image and an optimum luminance of the pseudo defect element image according to the first embodiment.

For an optimum luminance (the luminance after the change) kc of the pseudo defect element image 8 in relation to the luminance ka of the synthesization position G in the normal target image 7, a predetermined relationship is established based on a regression expression.

Therefore, the luminance ka of the synthesization position G in the normal target image 7 is detected, and the optimum luminance kc of the pseudo defect element image 8 is calculated using the regression expression based on the detected luminance ka of the synthesization position G in the normal target image 7.

Then, if a luminance difference is present between the detected actual luminance kb of the pseudo defect element image 8 and the optimum luminance kc of the pseudo defect element image 8, the actual luminance kb of the pseudo defect element image 8 is changed to the optimum luminance kc of the pseudo defect element image 8. Then, the pseudo defect target image is generated by synthesizing the pseudo defect element image 8 whose luminance is changed at the synthesization position in the normal target image.

As a result, an image further close to an actual defect can be efficiently generated.

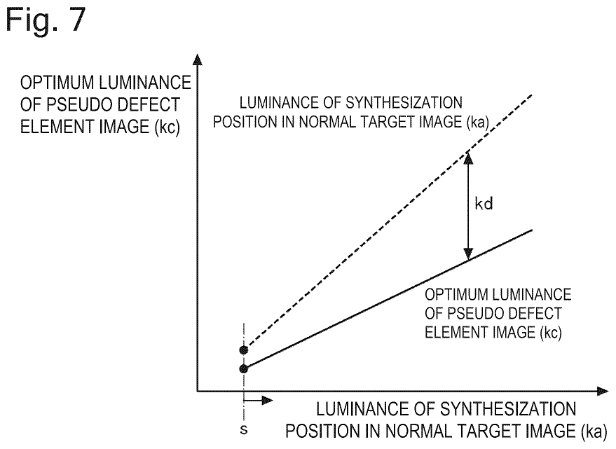

FIG. 7 is a graph indicating the luminance difference between the luminance of the synthesization position in the normal target image and the optimum luminance of the pseudo defect element image according to the first embodiment.

As the luminance ka of the synthesization position G in the normal target image 7 increases, the optimum luminance kc of the pseudo defect element image 8 increases.

More specifically, as the luminance ka of the synthesization position G in the normal target image 7 increases, a luminance difference kd between the luminance ka of the synthesization position G in the normal target image 7 and the optimum luminance kc of the pseudo defect element image 8 increases.

Due to that, although an increase in the luminance ka of the synthesization position G in the normal target image 7 leads to more sharp contrast to the actual luminance kb of the pseudo defect element image 8, an increase in the luminance kb of the pseudo defect element image 8 to the optimum luminance kc of the pseudo defect element image 8 prevents the pseudo defect element image 8 from becoming too sharp, and, further, contributes to efficiently generating an image close to an actual defect.

Further, the present embodiment is configured to synthesize the pseudo defect element image 8 if the luminance ka of the synthesization position G in the normal target image 7 is equal to or higher than a threshold value s, and refrain from synthesizing the pseudo defect element image 8 if the luminance ka of the synthesization position G in the normal target image 7 is lower than the threshold value s.

If the luminance ka of the synthesization position G in the normal target image 7 is lower than the threshold value s, the luminance difference kd to the luminance kb of the pseudo defect element image 8 reduces and this makes a correct inspection determination impossible. Due to this configuration, the present embodiment can prevent that and improve the determination accuracy of the inspection.

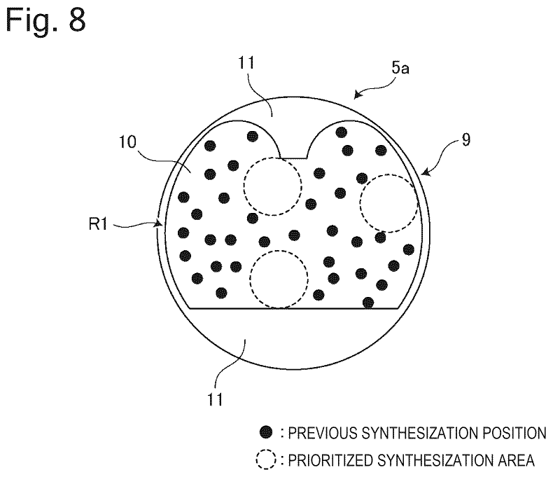

FIG. 8 illustrates an operation of the state parameter determination processing portion based on the state parameter history in the state parameter history storage portion according to the first embodiment.

The state parameter processing portion 403 confirms a previous synthesization position on a machined surface 10 in a region boundary R1 between the machined surface 10 having a cut mark and an as-cast surface 11 in a history target image 9 based on the history of the synthesization position G in the normal target image 7, which is stored in the state parameter history storage portion 404, and locates a prioritized synthesization area not yet synthesized (step S3 in FIG. 3).

This causes the synthesization position G in the normal target image 7 to be changed into the prioritized synthesization area to generate the pseudo defect target image, thereby contributing to improving the comprehensiveness of the pseudo defect element image 8.

The prioritized synthesization area can be set to not only the machined surface 10 in the region boundary R1 but also the as-cast surface 11 or on the region boundary R1.

Further, the history of the state parameter of the synthesization position G in the normal target image 7 or the state parameter of the pseudo defect element image 8 may be used instead of the synthesization position G in the normal target image 7.

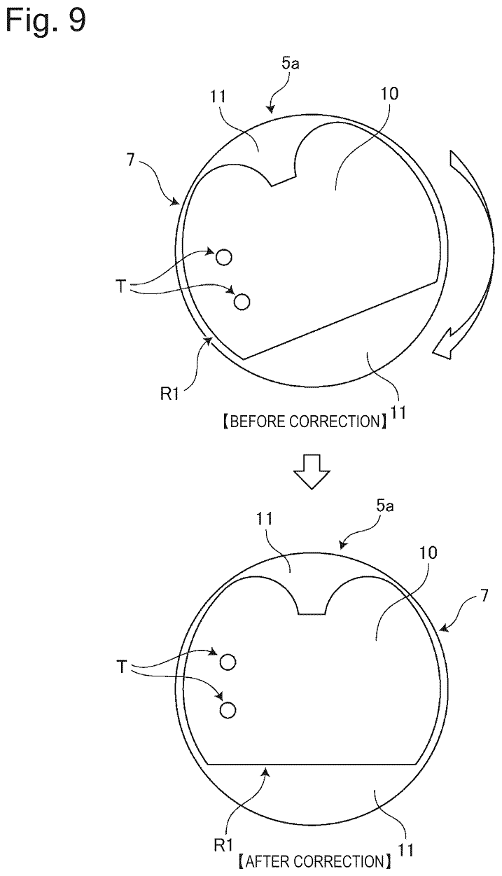

FIG. 9 illustrates an operation of the state parameter processing portion using the feature point according to the first embodiment.

The state parameter processing portion 403 is configured to, if there is a plurality of normal target images, extract a ring-shaped recess T attributed to a mold (the feature point), and correct the overall position of each of the plurality of normal target images in such a manner that the plurality of normal target images is arranged at the same overall position based on the ring-shaped recess T attributed to a mold (the feature point) (steps S14 and S15 in FIG. 3).

Due to that, the present embodiment can correct such a state that misalignment occurs due to imaging and the overall positions of the plurality of normal target images are subtly misaligned, thereby allowing a boundary position specifying mask image (a boundary position specifying mask) M stored in the boundary specifying mask image setting/storage portion 408, which will be described below, to be diverted among the plurality of normal target images, thereby contributing to efficiently generating an image close to an actual defect.

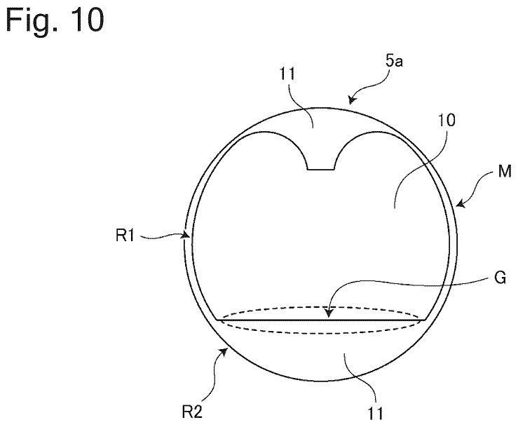

FIG. 10 illustrates an operation of the state parameter processing portion using the set boundary specifying mask image according to the first embodiment.

The state parameter processing portion 403 is configured to synthesize the pseudo defect element image 8 at the synthesization position G in the normal target image 7 in such a manner that a part of the pseudo defect element image 8 overlaps the region boundary R1 using the boundary position specifying mask image (the boundary position specifying mask) M having the region boundary R1 between the machined surface 10 and the as-cast surface 11 and a region boundary R2 indicating the outer periphery of the crown surface 5a of the piston 5, which is stored in the boundary specifying mask image setting/storage portion 408 (steps S9 and S18 in FIG. 3).

The present embodiment allows the pseudo defect element image 8 to be disposed on the region boundary R1 where it is difficult to make the determination in this manner, thereby contributing to further efficiently improving the determination accuracy of the inspection.

Next, advantageous effects of the first embodiment will be described.

The first embodiment brings about the following advantageous effects.

(1) The first embodiment is configured to detect the luminance as the state parameter of the synthesization position in the normal target image, change the luminance as the state parameter of the pseudo defect element image according to the luminance as the state parameter of the synthesization position in the normal target image, and synthesize the pseudo defect element image whose luminance as the state parameter is changed at the synthesization position in the normal target image, thereby generating the pseudo defect target image.

As a result, the first embodiment can generate a pseudo defect target image close to an actual defect, thereby improving the determination accuracy of the inspection.

(2) The first embodiment is configured to, if the luminance difference is present between the detected actual luminance kb of the pseudo defect element image 8 and the optimum luminance kc of the pseudo defect element image 8 calculated using the regression expression, change the actual luminance kb of the pseudo defect element image 8 to the optimum luminance kc of the pseudo defect element image 8, and synthesize the pseudo defect element image 8 whose luminance is changed at the synthesization position in the normal target image, thereby generating the pseudo defect target image.

As a result, the first embodiment can efficiently generate a pseudo defect target image further close to an actual defect.

(3) The first embodiment is configured in such a manner that, as the luminance ka of the synthesization position G in the normal target image 7 increases, the luminance difference kd between the luminance ka of the synthesization position G in the normal target image 7 and the optimum luminance kc of the pseudo defect element image 8 increases.

As a result, although an increase in the luminance ka of the synthesization position G in the normal target image 7 leads to more sharp contrast to the actual luminance kb of the pseudo defect element image 8, an increase in the luminance kb of the pseudo defect element image 8 to the optimum luminance ke of the pseudo defect element image 8 prevents the pseudo defect element image 8 from becoming too sharp, and, further, contributes to efficiently generating a pseudo defect target image close to an actual defect.

(4) The first embodiment is configured to synthesize the pseudo defect element image 8 if the luminance ka of the synthesization position G in the normal target image 7 is equal to or higher than the threshold value s, and refrain from synthesizing the pseudo defect element image 8 if the luminance ka of the synthesization position G in the normal target image 7 is lower than the threshold value s.

If the luminance ka of the synthesization position G in the normal target image 7 is lower than the threshold value s, the luminance difference kd to the luminance kb of the pseudo defect element image 8 reduces and this makes a correct inspection determination impossible. Due to this configuration, the first embodiment can prevent that and improve the determination accuracy of the inspection.

(5) The state parameter processing portion 403 is configured to confirm the previous synthesization position on the machined surface 10 in the region boundary R1 between the machined surface 10 and the as-cast surface 11 in the history target image 9 based on the history of the synthesization position G in the normal target image 7, which is stored in the state parameter history storage portion 404, locate the prioritized synthesization area not yet synthesized, and change the synthesization position of the pseudo defect element image 8 into the prioritized synthesization area, thereby generating the pseudo defect target image.

As a result, the first embodiment can improve the comprehensiveness of the pseudo defect target image.

(6) The state parameter processing portion 403 is configured to, if there is a plurality of normal target images, extract the ring-shaped recess T attributed to a mold (the feature point), and correct the overall position of each of the plurality of normal target images in such a manner that the plurality of normal target images is arranged at the same overall position based on the ring-shaped recess T attributed to a mold (the feature point).

As a result, the first embodiment can correct such a state that misalignment occurs due to imaging and the overall positions of the plurality of normal target images are subtly misaligned, thereby allowing the boundary position specifying mask image stored in the boundary specifying mask image setting/storage portion 408 to be diverted among the plurality of normal target images, thereby contributing to efficiently generating a pseudo defect target image close to an actual defect.

(7) The state parameter processing portion 403 is configured to synthesize the pseudo defect element image 8 at the synthesization position G in the normal target image 7 in such a manner that a part of the pseudo defect element image 8 overlaps the region boundary R1 using the boundary position specifying mask image M having the region boundary R1 between the machined surface 10 and the as-cast surface 11 and the region boundary R2 indicating the outer periphery of the crown surface 5a of the piston 5, which is stored in the boundary specifying mask image setting/storage portion 408, thereby generating the pseudo defect target image.

As a result, the first embodiment allows the pseudo defect element image 8 to be disposed on the region boundary R1 where it is difficult to make the determination, thereby contributing to further efficiently improving the determination accuracy of the inspection.

### Second Embodiment

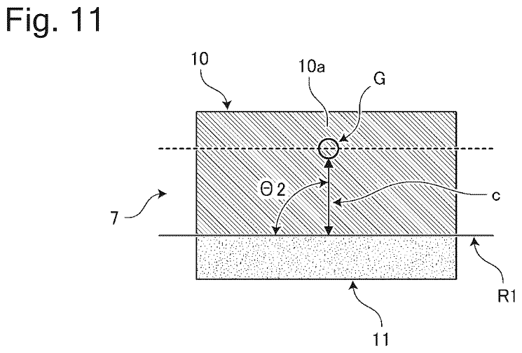

FIG. 11 illustrates a state parameter of the synthesization position in the normal target image according to the second embodiment.

The first embodiment uses the luminance ka of the synthesization position G in the normal target image 7 as the state parameter (the state) of the synthesization position in the normal target image by the normal target image synthesization position state detection processing portion 402, while the second embodiment is configured to use a distance c of the synthesization position G in the normal target image 7 from the region boundary R1 between the machined surface 10 having a cut mark 10a and the as-cast surface 11, and an angle θ2 from the region boundary R1 as the state parameter (the state) of the synthesization position in the normal target image.

Other than that, the second embodiment is configured similarly to the first embodiment, and therefore will be described assigning the same reference numerals to similar components and omitting the descriptions thereof.

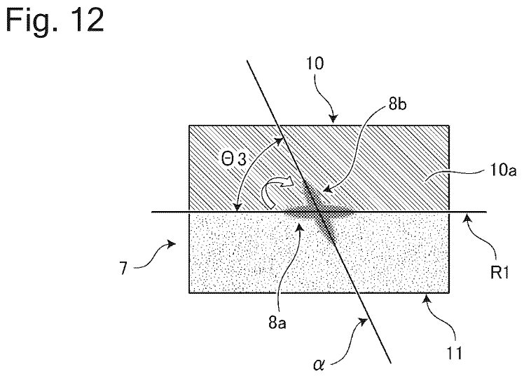

FIG. 12 illustrates a change in the angle of the pseudo defect element image at the synthesization position on the region boundary according to the second embodiment.

When the axis α of the pseudo defect element image 8 in the major diameter direction is located right on the region boundary R1 between the machined surface 10 having the cut mark 10a and the as-cast surface 11, this makes it difficult to discriminate the region boundary R1 and the pseudo defect element image 8 from each other, thus impairing the determination accuracy of the inspection. Therefore, the second embodiment is configured to generate the pseudo defect target image by synthesizing the pseudo defect element image 8 at the synthesization position in the normal target image after the axis α of the pseudo defect element image 8 in the major diameter direction is rotated from the region boundary R1 by an angle θ3 larger than a predetermined angle θa.

For example, the predetermined angle θa is 45°.

As a result, the second embodiment brings about an advantageous effect of being able to generate a pseudo defect target image further close to an actual defect even near the region boundary R1 in addition to the advantageous effects of the first embodiment.

### Third Embodiment

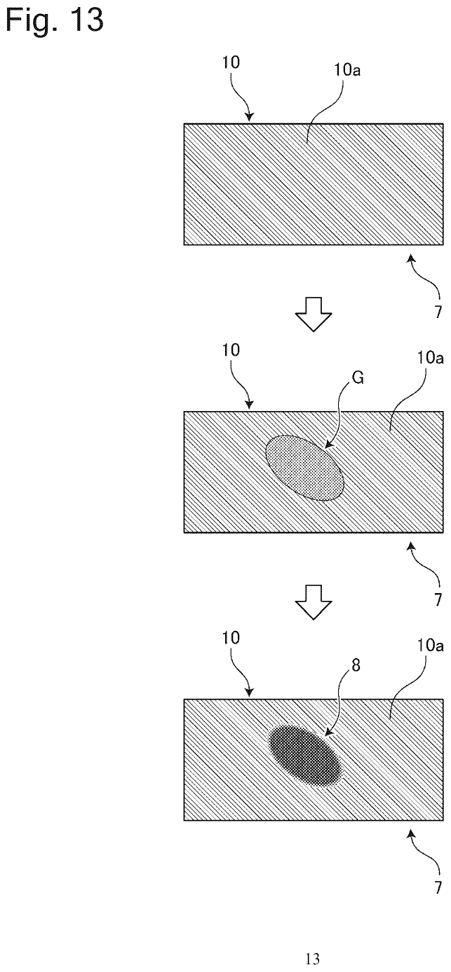

FIG. 13 illustrates filter processing of the synthesization position in the normal target image according to a third embodiment.

The first embodiment is configured to directly synthesize the pseudo defect element image 8 whose luminance is changed at the synthesization position G in the normal target image 7 of the machined surface 10 having the cut mark 10a, which is the crown surface 5a of the piston 5. On the other hand, the third embodiment is configured to generate the pseudo defect target image by synthesizing the pseudo defect element image 8 after applying smoothing filter processing (filter processing) for smoothing the synthesization position G in the normal target image 7 of the machined surface (the surface type) 10 having the cut mark 10a to remove the cut mark and change the surface state.

Other than that, the third embodiment is configured similarly to the first embodiment, and therefore will be described assigning the same reference numerals to similar components and omitting the descriptions thereof.

Due to that, the third embodiment can eliminate the influence of the cut mark 10a of the machined surface 10, thereby generating a pseudo defect target image further close to an actual defect.

As a result, the third embodiment brings about an advantageous effect of being able to generate a pseudo defect target image not affected by the cut mark of the machined surface 10 and generate an image further close to an actual defect in addition to the advantageous effects of the first embodiment.

[Other Embodiments] Having described the embodiments for implementing the present invention, the specific configuration of the present invention is not limited to the configuration of the embodiments, and the present invention also includes a design modification and the like thereof made within a range that does not depart from the spirit of the present invention, if any.

For example, the inspection target is not limited to the piston, and the machine learning is not limited to the deep learning, which is a multi-layered version of a neural network.

Further, the pose control portion changes the pose of the piston by means of the robot, but may fulfill this function by changing the position of the camera.

The present invention shall not be limited to the above-described embodiments, and includes various modifications. For example, the above-described embodiments have been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2023-088315 filed on May 30, 2023, The entire disclosure of Japanese Patent Application No. 2023-088315 filed on May 30, 2023 including the specification, the claims, the drawings, and the abstract is incorporated herein by reference in its entirety.

### REFERENCE SIGNS LIST

1 inspection apparatus
4a pseudo defect target image generation portion
412 learning processing portion
414 determination processing portion
5 piston (inspection target)
7 normal target image
8 pseudo defect element image
10 machined surface (surface type or state)
11 as-cast surface (surface type or state)
a major diameter (size or state)
b minor diameter (size or state)
c distance of synthesization position in normal target image from region boundary (state)
α axis in major diameter direction
θ1 angle of axis in major diameter direction (state)
θ2 angle of synthesization position in normal target image from region boundary (state)
θa predetermined angle of axis in major diameter direction
G synthesization position in normal target image
ka luminance of synthesization position in normal target image (background luminance or state)
kb actual luminance of pseudo defect element image (state)
kc optimum luminance of pseudo defect element image (luminance of pseudo defect element image after change)
kd luminance difference between luminance of synthesization position in normal target image and optimum luminance of pseudo defect element image
R1 region boundary
s threshold value of luminance of synthesization position in normal target image

1. An inspection apparatus configured to detect a defect in an inspection target using a target image acquired by imaging the inspection target, the inspection apparatus comprising:
a pseudo defect target image generation portion configured to generate a pseudo defect target image by synthesizing a pseudo defect element image mimicking a defective portion with a normal target image, the pseudo defect target image generation portion being configured to change at least one of a state of the pseudo defect element image, a synthesization position in the normal target image, or a state of the synthesization position in the normal target image according to the synthesization position in the normal target image at which the pseudo defect element image is synthesized, the state of the synthesization position in the normal target image, and the state of the pseudo defect element image, and synthesize the pseudo defect element image at the synthesization position in the normal target image;
a learning processing portion configured to generate a determination model by causing the pseudo defect target image to be machine-learned; and
a determination processing portion configured to detect the defect from a target image acquired by imaging the inspection target using the determination model.

2. The inspection apparatus according to claim 1, wherein the state of the synthesization position in the normal target image is at least one of a luminance, a luminance variation, a distance from a region boundary, an angle from the region boundary, or a surface type.

3. The inspection apparatus according to claim 1, wherein the state of the pseudo defect element image is at least one of a type, a size, an aspect ratio, an angle, or a luminance.

4. The inspection apparatus according to claim 2, wherein the state of the synthesization position in the normal target image is the luminance, and
wherein the pseudo defect target image generation portion changes a luminance of the pseudo defect element image according to a background luminance corresponding to the luminance of the synthesization position in the normal target image, and synthesizes the pseudo defect element image at the synthesization position in the normal target image.

5. The inspection apparatus according to claim 4, wherein the pseudo defect target image generation portion changes the luminance in such a manner that a luminance difference between the background luminance and the luminance of the pseudo defect element image after the change is larger when the background luminance of the synthesization position in the normal target image is high than when the background luminance of the synthesization position in the normal target image is low, and synthesizes the pseudo defect element image at the synthesization position in the normal target image.

6. The inspection apparatus according to claim 2, wherein the state of the synthesization position in the normal target image is the luminance, and
wherein the pseudo defect target image generation portion synthesizes the pseudo defect element image at the synthesization position in the normal target image when a background luminance corresponding to the luminance of the synthesization position in the normal target image is equal to or higher than a threshold value.

7. The inspection apparatus according to claim 2, wherein the state of the synthesization position in the normal target image is the surface type, and
wherein the pseudo defect target image generation portion synthesizes the pseudo defect element image at the synthesization position in the normal target image after applying filter processing to the synthesization position in the normal target image according to the surface type.

8. The inspection apparatus according to claim 7, wherein a filter used in the filter processing is a smoothing filter for smoothing the synthesization position in the normal target image.

9. The inspection apparatus according to claim 2, wherein the state of the synthesization position in the normal target image is the distance from the region boundary, and
wherein, when a part of the pseudo defect element image is located at a distance where it overlaps the region boundary and the pseudo defect element image is shaped like an ellipse having a major diameter and a minor diameter, the pseudo defect target image generation portion synthesizes the pseudo defect element image at the synthesization position in the normal target image in such a manner that an axis in a direction of the major diameter is arranged at an angle larger than a predetermined angle with respect to the region boundary.

10. The inspection apparatus according to claim 1, wherein the pseudo defect target image generation portion
stores the synthesization position in the normal target image, the state of the synthesization position in the normal target image, and/or the state of the pseudo defect element image as a history,
changes at least one of the state of the pseudo defect element image, the synthesization position in the normal target image, or the state of the synthesization position in the normal target image based on the history, and
synthesizes the pseudo defect element image at the synthesization position in the normal target image.

11. The inspection apparatus according to claim 1, wherein, when there is a plurality of the normal target images, the pseudo defect target image generation portion
extracts a location and a shape serving as a feature point in each of the plurality of normal target images, and
corrects an overall position of each of the plurality of normal target images based on a position of the feature point in each of the plurality of normal target images, and determines a position at which the pseudo defect element image is synthesized.

12. The inspection apparatus according to claim 1, wherein the pseudo defect target image generation portion
sets a boundary position specifying mask near a region boundary to the normal target image, and
synthesizes the pseudo defect element image at the synthesization position in the normal target image in such a manner that a part of the pseudo defect element image overlaps the region boundary of the boundary position specifying mask.

13. An inspection method for detecting a defect in an inspection target using a target image acquired by imaging the inspection target, the inspection method comprising:
a synthesization step of changing at least one of a state of a pseudo defect element image, a synthesization position in a normal target image, or a state of the synthesization position in the normal target image according to the synthesization position in the normal target image at which the pseudo defect element image is synthesized, the state of the synthesization position in the normal target image, and the state of the pseudo defect element image, and synthesizing the pseudo defect element image at the synthesization position in the normal target image, thereby generating a pseudo defect target image;
a determination model generation step of generating a determination model by causing the pseudo defect target image to be machine-learned; and
a determination step of detecting the defect from a target image acquired by imaging the inspection target using the determination model.
